(19) United States
(12) Patent Application Publication
(10) Pub. No.: US 2026/0065534 A1
(43) Pub. Date: Mar. 5, 2026

(54) METHOD AND SYSTEM FOR GENERATING SYNTHETIC IMAGE

(71) Applicant: MORAI INC., Seoul (KR)

(72) Inventor: Hojun LIM, Seoul (KR)

(21) Appl. No.: 19/382,711

(22) Filed: Nov. 7, 2025

Related U.S. Application Data
(63) Continuation of application No. PCT/KR2025/005689, filed on Apr. 28, 2025.

(30) Foreign Application Priority Data
Apr. 26, 2024 (KR) 10-2024-0056122

(51) Int. Cl. G06T 11/00; G06T 7/11

(52) U.S. Cl. CPC G06T 11/10; G06T 7/11; G06T 2207/10024; G06T 2207/30252

(57) ABSTRACT

A method for generating a synthetic image includes acquiring a target image of a first domain style, generating a first image of the first domain style representing a first type of object in the target image, generating a second image of the first domain style representing a second type of object in the target image, generating a first partial synthetic image of a second domain style based on the first image, using a first image generation model, generating a second partial synthetic image of the second domain style based on the second image, using a second image generation model, and generating a synthetic image of the second domain style based on the first partial synthetic image and the second partial synthetic image.

### CROSS-REFERENCE TO RELATED APPLICATION

The present application is a continuation of International Patent Application No. PCT/KR2025/005689, filed on Apr. 28, 2025, which is based upon and claims the benefit of priority to Korean Patent Application No. 10-2024-0056122, filed in the Korean Intellectual Property Office on Apr. 26, 2024, the entire contents of which are hereby incorporated by reference.

### BACKGROUND

### Field

The present disclosure relates to a method and system for generating a synthetic image used in an autonomous driving simulation.

### Description of Related Art

As automobile-related technologies such as IT, electricity, and electronics have developed, autonomous driving technology that utilizes all of these has been attracting attention. Autonomous driving technology is a technology that controls a vehicle without driver intervention, and is a technology that makes driving decisions for the vehicle by monitoring the driving environment through various sensors mounted on the vehicle.

Meanwhile, an autonomous driving simulator is trained using synthetic images (e.g., virtual images) similar to a vehicle's real driving environment as training data. However, a gap exists between synthetic images and real images used as training data for the autonomous driving simulator, and if this gap is not properly handled, there is a problem that the learning effect of the autonomous driving simulator deteriorates. This problem degrades the performance of the autonomous driving simulator and acts as a factor limiting the usability of autonomous driving technology in application fields.

### SUMMARY

### Technical Problem

The present disclosure provides a method and apparatus (system) for generating a synthetic image to solve the above-mentioned problems.

The present disclosure may be implemented in various ways, including a method, an apparatus (system), or a computer program stored on a readable storage medium.

In some embodiments, a method for generating a synthetic image, performed by at least one processor, is provided. The method includes acquiring a target image of a first domain style, generating a first image of the first domain style representing a first type of object in the target image, generating a second image of the first domain style representing a second type of object in the target image, generating a first partial synthetic image of a second domain style based on the first image, using a first image generation model, generating a second partial synthetic image of the second domain style based on the second image, using a second image generation model, and generating a synthetic image of the second domain style based on the first partial synthetic image and the second partial synthetic image, wherein the first domain style and the second domain style are different from each other.

In some embodiments, the first domain style may be a synthetic domain style, and the second domain style may be a realistic domain style.

In some embodiments, the first type of object may be an object distinguished and defined for each instance object, and the second type of object may be an object distinguished and defined as a class according to an attribute of the object. For example, the first type of object may be an object distinguished on a per-instance basis, and the second type of object may be an object distinguished at a class level.

In some embodiments, the first image may include RGB information for the first type of object, and the second image may include segmentation information for the second type of object.

In some embodiments, the first image generation model may be a model trained to generate an output image of the second domain style based on an input image of the first domain style.

In some embodiments, the second image generation model may be a model trained to generate an output image of the second domain style based on segmentation information.

In some embodiments, the generating the synthetic image of the second domain style may include generating a combined image by combining the first partial synthetic image and the second partial synthetic image, extracting at least a partial region in the combined image where the first partial synthetic image and the second partial synthetic image are adjacent, and transforming first color characteristics information for the at least a partial region.

In some embodiments, the transforming the first color characteristics information may include extracting, from the target image, second color characteristics information corresponding to the at least partial region, and transforming the first color characteristics information for the at least partial region in the combined image into the second color characteristics information.

In some embodiments, the first type of object may include a dynamic object and a first static object, the second type of object may include a second static object, and the first static object may be an object associated with traffic information.

In some embodiments, a computer-readable non-transitory recording medium on which are recorded instructions that, when executed by a computer, cause the computer to perform the aforementioned methods is provided.

In some embodiments, an information processing system includes a communication module, a memory, and at least one processor connected to the memory and configured to execute at least one computer-readable program included in the memory. The at least one program includes instructions for acquiring a target image of a first domain style, generating a first image of the first domain style representing a first type of object in the target image, generating a second image of the first domain style representing a second type of object in the target image, generating a first partial synthetic image of a second domain style based on the first image, using a first image generation model, generating a second partial synthetic image of the second domain style based on the second image, using a second image generation model, and generating a synthetic image of the second domain style based on the first partial synthetic image and the second partial synthetic image, and wherein the first domain style is different from the second domain style.

According to some embodiments of the present disclosure, by generating a synthetic image using different image generation models according to the type of object for a single image, a higher-quality image with greater realism may be generated.

According to some embodiments of the present disclosure, the time and cost required to implement a target image of a first domain style similar to actual reality using computer graphics or the like may be reduced.

According to some embodiments of the present disclosure, by using a second image generation model, a more realistic second partial synthetic image that directly reflects the styles of objects existing in actual reality may be generated.

According to some embodiments of the present disclosure, the color characteristics (or color tone) of the boundary portion between the first partial synthetic image and the second partial synthetic image in the combined image is corrected to connect naturally, so that a more natural, high-quality synthetic image of the second domain style may be generated.

The effects of the present disclosure are not limited to the effects mentioned above, and other unmentioned effects will be clearly understood by a person of ordinary skill in the art to which the present disclosure pertains (hereinafter referred to as “a person of ordinary skill”) from the description of the claims.

### BRIEF DESCRIPTION OF THE DRAWINGS

Embodiments of the present disclosure will be described with reference to the accompanying drawings described below, wherein like reference numerals denote like elements, but are not limited thereto.

FIG. 1 illustrates an example of generating a synthetic image of a second domain style from a target image of a first domain style according to an embodiment of the present disclosure.

FIG. 2 is a schematic diagram illustrating a configuration in which an information processing system is communicably connected with a plurality of user terminals to generate a synthetic image according to an embodiment of the present disclosure.

FIG. 3 is a block diagram illustrating the internal configuration of a user terminal and an information processing system according to an embodiment of the present disclosure.

FIG. 4 illustrates an example of generating a first partial synthetic image based on a first image using a first image generation model according to an embodiment of the present disclosure.

FIG. 5 illustrates an example of generating a second partial synthetic image based on a second image using a second image generation model according to an embodiment of the present disclosure.

FIG. 6 illustrates an example of generating a synthetic image of a second domain style based on a first partial synthetic image and a second partial synthetic image according to an embodiment of the present disclosure.

FIG. 7 illustrates an example of generating a synthetic image of a second domain style based on a combined image according to an embodiment of the present disclosure.

FIG. 8 illustrates an example of an image generated according to a synthetic image generation method according to an embodiment of the present disclosure.

FIG. 9 is a flowchart illustrating a synthetic image generation method according to an embodiment of the present disclosure.

### DETAILED DESCRIPTION

Hereinafter, specific details for carrying out the present disclosure will be described in detail with reference to the accompanying drawings. However, in the following description, detailed descriptions of well-known functions or configurations will be omitted if they are likely to unnecessarily obscure the gist of the present disclosure.

In the accompanying drawings, the same or corresponding components are assigned the same reference numerals. In addition, in the description of the following embodiments, a repeated description of the same or corresponding components may be omitted. However, even if a description of a component is omitted, the component is not intended to be excluded from any embodiment.

The advantages and features of the disclosed embodiments and the methods of achieving them will become clear with reference to the embodiments described below in conjunction with the accompanying drawings. However, the present disclosure is not limited to the embodiments disclosed below and may be embodied in many different forms; rather, these embodiments are provided so that the present disclosure will be thorough and complete, and will fully convey the scope of the invention to a person of ordinary skill in the art.

The terms used in this specification will be briefly explained, and the disclosed embodiments will be described in detail. The terms used in this specification have been selected from currently widely used general terms in consideration of the functions in the present disclosure, but the terms may vary depending on the intention of a person skilled in the relevant art, legal precedent, or the emergence of new technology. In addition, in certain cases, there are terms arbitrarily selected by the applicant, in which case the meaning will be described in detail in the corresponding description part of the invention. Therefore, the terms used in the present disclosure should be defined based on the meaning of the terms and the content throughout the present disclosure, not just the names of the terms.

In this specification, a singular expression includes a plural expression unless the context clearly dictates otherwise. In addition, a plural expression includes a singular expression unless the context clearly dictates otherwise. Throughout the specification, when a part is said to “include” a certain component, it means that the part may further include other components, not excluding other components, unless there is a specific statement to the contrary.

In addition, the term ‘module’ or ‘unit’ used in the specification means a software or hardware component, and the ‘module’ or ‘unit’ performs certain roles. However, the ‘module’ or ‘unit’ is not limited to software or hardware. A ‘module’ or ‘unit’ may be configured to be in an addressable storage medium and may be configured to execute one or more processors. Thus, as an example, a ‘module’ or ‘unit’ may include at least one of software components, object-oriented software components, class components, and task components, and processes, functions, attributes, procedures, subroutines, segments of program code, drivers, firmware, microcode, circuits, data, databases, data structures, tables, arrays, or variables. The function provided in the components and ‘modules’ or ‘units’ may be combined into a smaller number of components and ‘modules’ or ‘units’ or may be further separated into additional components and ‘modules’ or ‘units’.

According to an embodiment of the present disclosure, a ‘module’ or ‘unit’ may be implemented as a processor and a memory. A ‘processor’ should be broadly interpreted to include a general-purpose processor, a central processing unit (CPU), a microprocessor, a digital signal processor (DSP), a controller, a microcontroller, a state machine, and the like. In some environments, a ‘processor’ may also refer to an application-specific integrated circuit (ASIC), a programmable logic device (PLD), a field programmable gate array (FPGA), etc. A ‘processor’ may also refer to a combination of processing devices, such as, for example, a combination of a DSP and a microprocessor, a combination of a plurality of microprocessors, a combination of one or more microprocessors combined with a DSP core, or any other such configuration. In addition, ‘memory’ should be broadly interpreted to include any electronic component capable of storing electronic information. ‘Memory’ may refer to various types of processor-readable media such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage devices, registers, and the like. A memory is said to be in electronic communication with a processor if the processor can read information from and/or write information to the memory. A memory integrated into a processor is in electronic communication with the processor.

In the present disclosure, a ‘system’ may include at least one of a server device and a cloud device, but is not limited thereto. For example, a system may be configured with one or more server devices. As another example, a system may be configured with one or more cloud devices. As yet another example, a system may be configured and operated with a server device and a cloud device together.

In the present disclosure, ‘each of a plurality of A’ or ‘each of a plurality of A’ may refer to each of all components included in the plurality of A, or may refer to each of some components included in the plurality of A.

In the present disclosure, ‘domain style’ refers to the visual characteristics and/or artistic style of an image, and may represent a unique combination of the Field Of View (FOV) of the camera that captured the image, camera parameters, the image's color, texture, pattern, shape, and other visual elements that define the overall look and aesthetic quality of the image. For example, the domain style of an image may include a synthetic domain style such as computer graphics (for example, computer game graphics), and a realistic domain style such as a real world captured with a specific camera. In addition, if the cameras that capture the real world are different from each other, the images taken by each camera may have different domain styles depending on the various characteristics of the cameras.

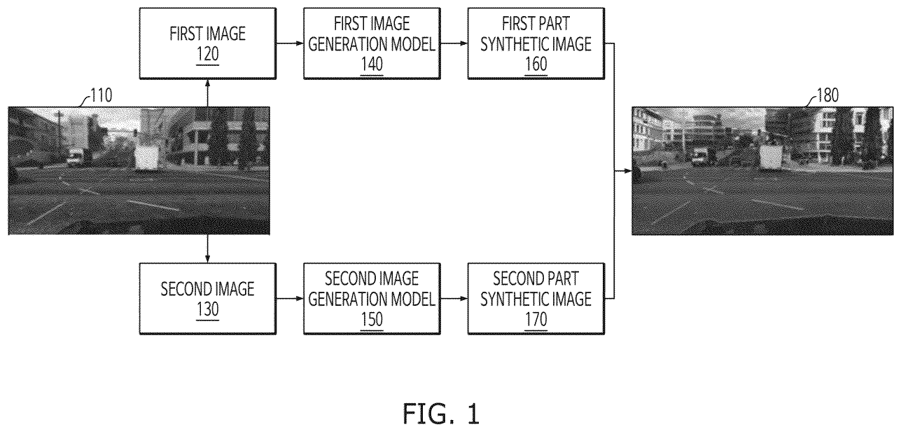

FIG. 1 illustrates an example of generating a synthetic image 180 of a second domain style from a target image 110 of a first domain style according to an embodiment of the present disclosure. As shown, a processor (e.g., at least one processor of an information processing system that generates a synthetic image) may acquire a target image 110 of a first domain style. Here, the first domain style may be a synthetic domain style generated through a computer simulation or a computer game, but is not limited thereto. For example, the first domain style may include various types of domain styles (e.g., cartoon image style, pointillism image style, etc.).

In an embodiment, the processor may identify/extract a first type of object in the target image 110 of the first domain style. Here, the first type of object may refer to an object distinguished and defined for each instance object. As a specific example, the first type of object may include an object that needs to be clearly distinguished and defined with a boundary for each object even among objects of the same class. For example, the first type of object may include a dynamic object such as a vehicle, a pedestrian, or a bicycle. Additionally, the first type of object may include an object related to vehicle driving, which contains fine grained information where even minor damage to the content associated with the object is not allowed. For example, the first type of object may include a static object related to traffic information, such as a traffic sign, a traffic light, or a lane.

In an embodiment, the processor may generate a first image 120 of the first domain style representing the first type of object. Here, the first image 120 may include RGB information for the first type of object identified/extracted from the target image 110 of the first domain style.

In an embodiment, the processor may identify/extract a second type of object in the target image 110 of the first domain style. Here, the second type of object is an object distinguished and defined as a class according to an attribute of the object, and the second type of object may refer to an object that does not require distinction by instance object. For example, the second type of object may include a static object with little relevance to vehicle driving, such as a building or a tree. In addition, the second type of object may include objects with ambiguous boundaries or a low need for clearly defining their shapes, such as the sky or clouds. Here, the types of classes are variable and may change depending on the application in which they are used. In addition, all objects except the first type of object may be classified and defined as the second type of object.

In an embodiment, the processor may generate a second image 130 of the first domain style representing the second type of object. Here, the second image 130 may include segmentation information for the second type of object identified/extracted/generated from the target image 110 of the first domain style.

In an embodiment, the processor may generate a first partial synthetic image 160 of a second domain style based on the first image 120, using a first image generation model 140. Here, the first domain style and the second domain style may be different from each other. For example, the first domain style may be a synthetic domain style and the second domain style may be a realistic domain style, such as a real world captured with a specific camera, but is not limited thereto. For example, the first domain style and the second domain style may be two different types among various domain styles (for example, cartoon image style, pointillism image style, hand-drawn image style, etc.).

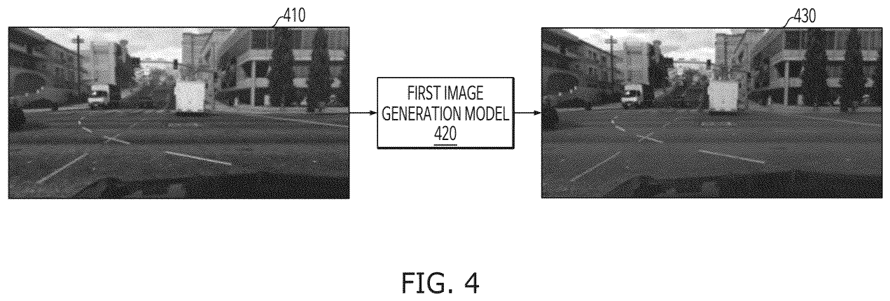

In an embodiment, the first image generation model 140 may be a model (for example, a neural network model) trained to receive an image of the first domain style as input and generate an image of the second domain style as output. For example, the first image generation model 140 may be a model trained based on a pair of a first training image of the first domain style and a second training image of the second domain style. Accordingly, the first image generation model 140 may generate the first partial synthetic image 160 of the second domain style based on the first image 120 of the first domain style. An example of generating the first partial synthetic image 160 based on the first image 120 by the first image generation model 140 will be described in detail later with reference to FIG. 4.

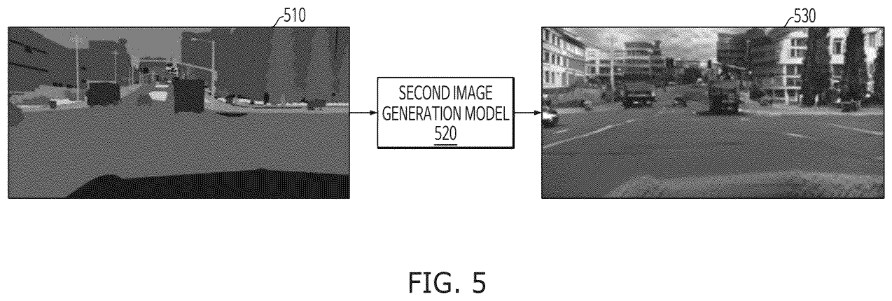

In an embodiment, the processor may generate a second partial synthetic image 170 of the second domain style based on the second image 130, using a second image generation model 150. Here, the second image generation model 150 may be a model trained to generate an image of the second domain style based on segmentation information. For example, the second image generation model 150 may be trained based on a pair(s) of a third training image of the second domain style and segmentation information generated from the third training image of the second domain style. Accordingly, the second image generation model 150 may generate the second partial synthetic image 170 in which second-type objects of the second domain style are generated within the corresponding segmentation region, based on the segmentation information for the second-type objects in the second image 130. An example of generating the second partial synthetic image 170 based on the second image 130 by the second image generation model 150 will be described in detail later based on FIG. 5.

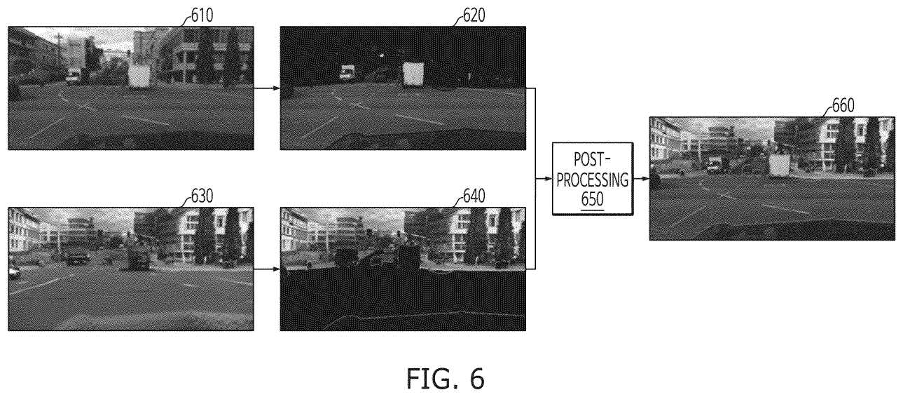

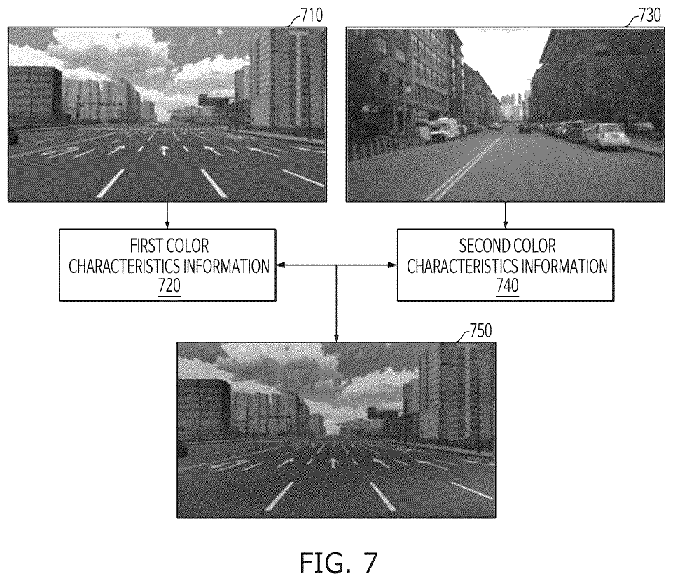

In an embodiment, the processor may generate a synthetic image 180 of the second domain style based on the first partial synthetic image 160 and the second partial synthetic image 170. For example, the processor may generate a combined image by combining the first partial synthetic image 160 for the first type of object and the second partial synthetic image 170 for the second type of object. In addition, the processor may perform a post-processing operation on a region where the first partial synthetic image 160 and the second partial synthetic image 170 are adjacent in the combined image to generate the synthetic image 180 of the second domain style. An example of generating the synthetic image 180 of the second domain style based on the first partial synthetic image 160 and the second partial synthetic image 170 will be described in detail later based on FIGS. 6 and 7.

With this configuration, the processor can generate a higher-quality image with greater realism by generating a synthetic image for a single image using different image generation models according to the type of object.

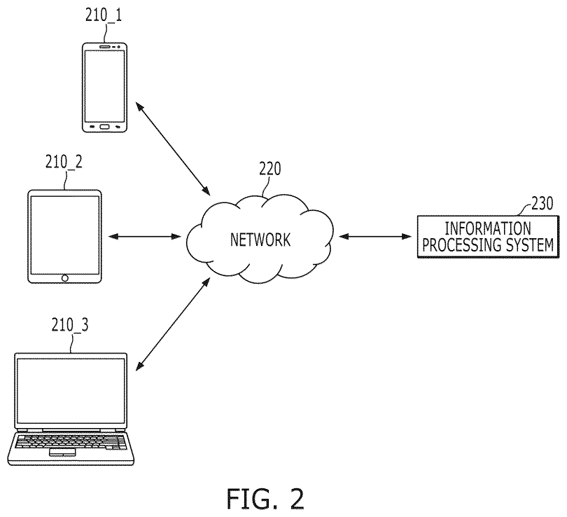

FIG. 2 is a schematic diagram illustrating a configuration in which an information processing system 230 is communicably connected with a plurality of user terminals 210_1, 210_2, and 210_3 to generate a synthetic image according to an embodiment of the present disclosure. As shown, the plurality of user terminals 210_1, 210_2, and 210_3 may be connected to an information processing system 230 that can generate a synthetic image via a network 220. Here, the plurality of user terminals 210_1, 210_2, and 210_3 may include the terminals of users who are provided with the generated synthetic image.

In an embodiment, the information processing system 230 may include one or more server devices and/or databases, or one or more distributed computing devices and/or distributed databases based on a cloud computing service, which can store, provide, and execute computer-executable programs (for example, downloadable applications) and data associated with synthetic image generation.

The synthetic image provided by the information processing system 230 may be provided to a user through an image generation application, a web browser, or a web browser extension program installed on each of the plurality of user terminals 210_1, 210_2, and 210_3. For example, the information processing system 230 may provide information corresponding to a synthetic image generation request received from the user terminals 210_1, 210_2, and 210_3 through the image generation application or the like, or may perform corresponding processing.

The plurality of user terminals 210_1, 210_2, and 210_3 may communicate with the information processing system 230 via the network 220. The network 220 may be configured to enable communication between the plurality of user terminals 210_1, 210_2, and 210_3 and the information processing system 230. The network 220 may be configured as a wired network such as Ethernet, Power Line Communication, telephone line communication device, and RS-serial communication, a wireless network such as a mobile communication network, Wireless LAN (WLAN), Wi-Fi, Bluetooth, and ZigBee, or a combination thereof, depending on the installation environment. The communication method is not limited, and may include not only communication methods utilizing communication networks that the network 220 may include (for example, mobile communication networks, wired internet, wireless internet, broadcasting networks, satellite networks, etc.), but also short-range wireless communication between the user terminals 210_1, 210_2, and 210_3.

Although FIG. 2 shows a mobile phone terminal 210_1, a tablet terminal 210_2, and a PC terminal 210_3 as examples of user terminals, the present disclosure is not limited thereto, and the user terminals 210_1, 210_2, and 210_3 may be any computing device capable of wired and/or wireless communication and on which a synthetic image generation service application or web browser, or a synthetic image generation service application or web browser, can be installed and executed. For example, a user terminal may include an AI speaker, a smartphone, a mobile phone, a navigation system, a computer, a laptop, a digital broadcasting terminal, a Personal Digital Assistant (PDA), a Portable Multimedia Player (PMP), a tablet PC, a game console, a wearable device, an Internet of Things (IoT) device, a synthetic reality (VR) device, an augmented reality (AR) device, a set-top box, etc. In addition, although FIG. 2 shows three user terminals 210_1, 210_2, and 210_3 communicating with the information processing system 230 via the network 220, the present disclosure is not limited thereto, and a different number of user terminals may be configured to communicate with the information processing system 230 via the network 220.

Although FIG. 2 exemplarily illustrates a configuration in which the user terminals 210_1, 210_2, and 210_3 are provided with a generated synthetic image by communicating with the information processing system 230, the present disclosure is not limited thereto. For example, the user terminals 210_1, 210_2, and 210_3 may directly generate a synthetic image without communicating with the information processing system 230.

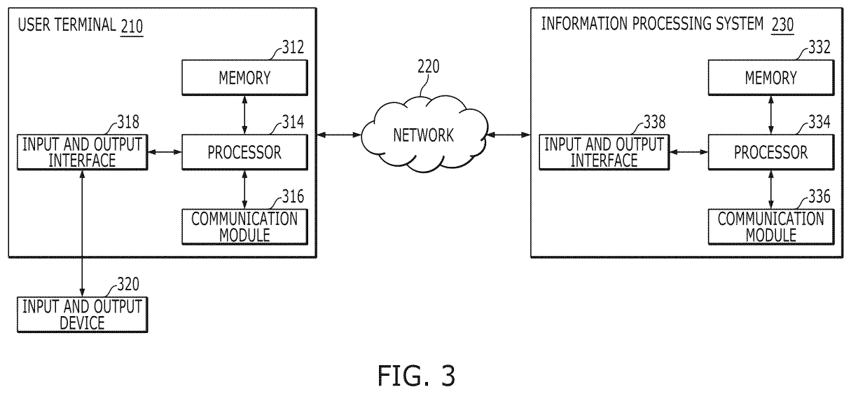

FIG. 3 is a block diagram illustrating the internal configuration of a user terminal 210 and an information processing system 230 according to an embodiment of the present disclosure. The user terminal 210 may refer to any computing device capable of executing an application, a web browser, etc., and capable of wired/wireless communication, and may include, for example, the mobile phone terminal 210_1, the tablet terminal 210_2, the PC terminal 210_3, etc. of FIG. 2. As shown, the user terminal 210 may include a memory 312, a processor 314, a communication module 316, and an input/output interface 318. Similarly, the information processing system 230 may include a memory 332, a processor 334, a communication module 336, and an input/output interface 338. As shown in FIG. 3, the user terminal 210 and the information processing system 230 may be configured to communicate information and/or data via the network 220 using their respective communication modules 316 and 336. In addition, an input/output device 320 may be configured to input information and/or data to the user terminal 210 or output information and/or data generated from the user terminal 210 through the input/output interface 318.

The memories 312 and 332 may include any non-transitory computer-readable recording medium. According to an embodiment, the memories 312 and 332 may include a permanent mass storage device such as a read only memory (ROM), a disk drive, a solid state drive (SSD), a flash memory, and the like. As another example, a non-volatile mass storage device such as a ROM, SSD, flash memory, disk drive, etc., may be included in the user terminal 210 or the information processing system 230 as a separate permanent storage device distinct from the memory. In addition, an operating system and at least one program code may be stored in the memories 312 and 332.

These software components may be loaded from a computer-readable recording medium separate from the memories 312 and 332. Such a separate computer-readable recording medium may include a recording medium that can be directly connected to the user terminal 210 and the information processing system 230, for example, a computer-readable recording medium such as a floppy drive, disk, tape, DVD/CD-ROM drive, memory card, and the like. As another example, the software components may be loaded into the memories 312 and 332 through the communication modules 316 and 336, not a computer-readable recording medium. For example, at least one program may be loaded into the memories 312 and 332 based on a computer program installed by files provided through the network 220 by developers or a file distribution system that distributes installation files of an application.

The processors 314 and 334 may be configured to process instructions of a computer program by performing basic arithmetic, logic, and input/output operations. Instructions may be provided to the processors 314 and 334 by the memories 312 and 332 or the communication modules 316 and 336. For example, the processors 314 and 334 may be configured to execute received instructions according to program code stored in a recording device such as the memories 312 and 332.

The communication modules 316 and 336 may provide a configuration or function for the user terminal 210 and the information processing system 230 to communicate with each other via the network 220, and may provide a configuration or function for the user terminal 210 and/or the information processing system 230 to communicate with another user terminal or another system (for example, a separate cloud system, etc.). For example, a request or data (for example, an image generation model training request, a synthetic image generation request, etc.) generated by the processor 314 of the user terminal 210 according to program code stored in a recording device such as the memory 312 may be transmitted to the information processing system 230 via the network 220 under the control of the communication module 316. Conversely, a control signal or command provided under the control of the processor 334 of the information processing system 230 may be received by the user terminal 210 through the communication module 316 of the user terminal 210 via the communication module 336 and the network 220.

The input/output interface 318 may be a means for interfacing with the input/output device 320. As an example, an input device may include a camera including an audio sensor and/or an image sensor, a keyboard, a microphone, a mouse, etc., and an output device may include a display, a speaker, a haptic feedback device, etc. As another example, the input/output interface 318 may be a means for interfacing with a device in which a configuration or function for performing input and output is integrated into one, such as a touchscreen. For example, a service screen configured using information and/or data provided by the information processing system 230 or another user terminal while the processor 314 of the user terminal 210 processes instructions of a computer program loaded in the memory 312 may be displayed on a display through the input/output interface 318. Although FIG. 3 shows the input/output device 320 not included in the user terminal 210, the present disclosure is not limited thereto, and the input/output device 320 may be configured as a single device with the user terminal 210. In addition, the input/output interface 338 of the information processing system 230 may be a means for interfacing with a device (not shown) for input or output that is connected to or may be included in the information processing system 230. Although FIG. 3 shows the input/output interfaces 318 and 338 as components configured separately from the processors 314 and 334, the present disclosure is not limited thereto, and the input/output interfaces 318 and 338 may be configured to be included in the processors 314 and 334.

The user terminal 210 and the information processing system 230 may include more components than the components in FIG. 3. However, it is not necessary to clearly show most conventional components. In an embodiment, the user terminal 210 may be implemented to include at least some of the above-described input/output devices 320. In addition, the user terminal 210 may further include other components such as a transceiver, a Global Positioning System (GPS) module, a camera, various sensors, a database, and the like.

While a program for training an artificial neural network model, an image generation application, etc., is operating, the processor 314 may receive text, images, videos, voice, and/or motions input or selected through an input device such as a touch screen connected to the input/output interface 318, a keyboard, a camera including an audio sensor and/or an image sensor, a microphone, etc., and may store the received text, images, videos, voice, and/or motions in the memory 312 or provide them to the information processing system 230 through the communication module 316 and the network 220.

The processor 314 of the user terminal 210 may be configured to manage, process, and/or store information and/or data received from the input/output device 320, another user terminal, the information processing system 230, and/or a plurality of external systems. The information and/or data processed by the processor 314 may be provided to the information processing system 230 through the communication module 316 and the network 220. The processor 314 of the user terminal 210 may transmit information and/or data to the input/output device 320 through the input/output interface 318 to output the information and/or data. For example, the processor 314 may output or display the received information and/or data on a screen of the user terminal 210.

The processor 334 of the information processing system 230 may be configured to manage, process, and/or store information and/or data received from a plurality of user terminals 210 and/or a plurality of external systems. The information and/or data processed by the processor 334 may be provided to the user terminal 210 through the communication module 336 and the network 220.

FIG. 4 illustrates an example of generating a first partial synthetic image 430 based on a first image 410 using a first image generation model 420 according to an embodiment of the present disclosure. In an embodiment, the first image generation model 420 may receive a first image 410 of a first domain style. Here, the first domain style may be a synthetic domain style, but is not limited thereto. In addition, the first image 410 may be an image representing a first type of object in a target image of the first domain style. The first type of object is an object distinguished and defined for each instance object, and may include a dynamic object (for example, a vehicle, a pedestrian, a bicycle, etc.) and a static object related to traffic information (for example, a traffic sign, a traffic light, a lane, etc.).

In an embodiment, the first image 410 may include RGB information for the first type of object. For example, a processor may identify/extract the first type of object in the target image of the first domain style, and then generate the first image 410 based on RGB information for pixels in the region constituting the identified first type of object.

In an embodiment, the first image generation model 420 may be a model trained to generate an output image of a second domain style based on an input image of a first domain style. For example, the first image generation model 420 may be a model trained based on a pair of a first training image of the first domain style and a second training image of the second domain style. In addition, the first training image and the second training image may include RGB information for objects in the images. Here, the domain styles of the first training image of the first domain style and the second training image of the second domain style are different from each other, but the appearances of the objects in the images may be identical or similar on a pixel-wise basis.

Accordingly, the first image generation model 420 may generate an output image in which the appearance of the objects in the input image is maintained, but the atmosphere, color characteristics, light intensity, etc., of the input image are changed. That is, the first image generation model 420 may generate a first partial synthetic image 430 in which the appearance of the first type of object in the first image 410 is maintained identically, but the atmosphere, color characteristics, light intensity, etc., of the image are changed, based on the first image 410. In other words, the domain styles of the first image 410 of the first domain style and the first partial synthetic image 430 of the second domain style are different from each other, but the appearances of the objects in the images may be identical or similar on a pixel-wise basis.

An image generated by the first image generation model 420 trained as described above has the advantage that the shapes of the objects in the image are not distorted and the content within the objects is not changed. However, if the appearances, textures, etc., of the objects are maintained completely as they are, the effect of the domain style change may be reduced even though the domain styles of the input image and the output image are different. As a specific example, when generating a realistic domain style output image from a synthetic domain style input image, the appearances, textures, etc., of objects generated through computer simulation or computer games are implemented as they are in the output image, which may reduce the realism of the output image.

Accordingly, in an embodiment, a processor may identify only a first type of object in a target image of a first domain style to generate a first image 410 representing the first type of object. Then, the processor causes the first image generation model 420 to generate a first partial synthetic image 430 of a second domain style based on the first image 410. For example, among the first-type objects included in the first image 410, objects related to vehicle driving (for example, traffic signs, lanes) may not have distortions in their appearance and content (for example, the content of a traffic sign or the direction of a lane) even after the first partial synthetic image is generated by the first image generation model 420.

On the other hand, for a second image representing a second type of object that is relatively less important for vehicle driving (for example, a building, the sky, a tree, etc.), the processor causes a second image generation model, not the first image generation model 420, to generate a second partial synthetic image. An example of generating the second partial synthetic image based on the second image using the second image generation model will be described in detail in FIG. 5.

In FIG. 4, for convenience of explanation, it is shown that the first image 410 and the first partial synthetic image 430 include not only the first type of object but also the second type of object. However, it will be understood that the first image generation model 420 selectively identifies/extracts only the RGB information for the first type of object among the objects in the first image 410 to generate the first partial synthetic image 430.

FIG. 5 illustrates an example of generating a second partial synthetic image 530 based on a second image 510 using a second image generation model 520 according to an embodiment of the present disclosure. In an embodiment, the second image generation model 520 may receive a second image 510. For example, the second image 510 may include segmentation information for a second type of object.

In an embodiment, a processor may identify/extract a second type of object in a target image of a first domain style and perform semantic segmentation on the identified second type of object to generate a second image 510. Here, the first domain style may be a synthetic domain style, but is not limited thereto. In addition, the second image 510 may be an image representing the second type of object in the target image of the first domain style. The second type of object is an object distinguished and defined as a class according to an attribute of the object, and may include a static object with little relevance to traffic information (for example, a building, the sky, a tree, etc.). All objects except the first type of object may be classified and defined as the second type of object.

In an embodiment, the second image generation model 520 may be a model trained to generate an output image of a second domain style (for example, an RGB image) based on segmentation information. For example, the second image generation model 520 may be trained based on a pair(s) of a third training image of the second domain style and segmentation information for objects in the third training image. Here, the second domain style may be a realistic domain style, such as a real world captured with a specific camera.

In an embodiment, the second image generation model 520 may generate a second partial synthetic image 530 of a second domain style based on segmentation information associated with a second type of object in a second image 510. For example, the second image generation model 520 may generate the second partial synthetic image 530 of the second domain style in which an object of the same class as the second type of object is generated in a segmentation region corresponding to the second type of object.

The second image generation model 520 trained as described above does not generate an output image in which the appearances and/or contents of the objects in the input image are implemented identically on a pixel-wise basis, but may be trained so that the styles of objects that are likely to exist in the real world are directly reflected in the objects in the output image. For example, the second image generation model 520 may generate a second partial synthetic image 530 in which an image is generated in the segmentation region of the second-type objects included in the second image 510, where the object is of the same class as the second-type object but with a style that directly reflects an object likely to exist in the real world. As a specific example, an image of an object existing in the real world may include images of objects that are difficult to implement with computer simulation or computer games (for example, the terrain, buildings, etc., of each country).

With this configuration, the time and cost required to implement a target image of a first domain style similar to actual reality using computer graphics or the like may be reduced, and by using the second image generation model 520, a more realistic second partial synthetic image that directly reflects the styles of objects existing in actual reality may be generated.

In FIG. 5, for convenience of explanation, it is shown that the second image 510 and the second partial synthetic image 530 include not only the second type of object but also the first type of object. However, it will be understood that the second image generation model 520 selectively identifies/extracts only the segmentation information for the second type of object among the objects in the second image 510 to generate the second partial synthetic image 530.

FIG. 6 illustrates an example of generating a synthetic image 660 of a second domain style based on first partial synthetic images 610 and 620 and second partial synthetic images 630 and 640 according to an embodiment of the present disclosure. In an embodiment, a processor may receive the first partial synthetic images 610 and 620 of the second domain style generated by a first image generation model. The first partial synthetic images 610 and 620 may be images generated based on a first image representing a first type of object in a target image of a first domain style. Therefore, the first partial synthetic images 610 and 620 may be images of the second domain style in which the first type of object is generated. Referring to FIG. 6, it can be confirmed that an image for the first type of object (for example, a vehicle, a lane, etc.) is generated in the first partial synthetic image 620.

In an embodiment, the processor may receive the second partial synthetic images 630 and 640 of the second domain style generated by a second image generation model. The second partial synthetic images 630 and 640 may be images generated based on a second image representing a second type of object in the target image of the first domain style. Therefore, the second partial synthetic images 630 and 640 may be images of the second domain style in which the second type of object is generated. Referring to FIG. 6, it can be confirmed that an image for the second type of object (for example, a building, the sky, a tree, etc.) is generated in the second partial synthetic image 640.

In an embodiment, the processor may generate a combined image by combining the first partial synthetic image 620 and the second partial synthetic image 640. Since the first partial synthetic image 620 generates the first type of object and the second partial synthetic image 640 generates the second type of object (all objects except the first type of object), the first partial synthetic image 620 and the second partial synthetic image 640 can be combined to be perfectly adjacent without any empty or overlapping regions in the combined image. However, in this case, the region where the first partial synthetic image 620 and the second partial synthetic image 640 are adjacent may be somewhat unnatural. Accordingly, the processor may perform a post-processing 650 operation on the combined image to generate the synthetic image 660 of the second domain style. A detailed description of this will be given later with reference to FIG. 7.

FIG. 7 illustrates an example of generating a synthetic image 750 of a second domain style based on a combined image 710 according to an embodiment of the present disclosure. In an embodiment, a processor may generate a combined image 710 by combining a first partial synthetic image and a second partial synthetic image. The processor may extract at least a partial region in the combined image 710 where the first partial synthetic image and the second partial synthetic image are adjacent, but is not limited thereto.

In an embodiment, the processor may calculate first color characteristics information 720 representing color characteristics information for the combined image 710. In addition, the processor may calculate second color characteristics information 740 representing color characteristics information for a target image 730 of a first domain style.

In an embodiment, the first color characteristics information 720 and the second color characteristics information 740 may be calculated through a Fourier transform. For example, the processor may perform a Fourier transform on the combined image 710 to obtain an amplitude map and a phase map. Here, the amplitude map is information related to light, color characteristics, etc., for the combined image 710, and may correspond to the first color characteristics information 720. For example, the amplitude map may be expressed as a two-dimensional coordinate system in which the horizontal axis and the vertical axis represent the horizontal frequency and the vertical frequency of the combined image 710, respectively, and each coordinate value on the coordinate system may represent the amplitude of the frequency component corresponding to the coordinate (e.g., the brightness of a pixel in the combined image 710). In addition, the phase map may be edge information for objects in the combined image 710. For example, the phase map may be expressed as a two-dimensional coordinate system in which the horizontal axis and the vertical axis represent the horizontal frequency and the vertical frequency of the combined image 710, respectively, and each coordinate value on the coordinate system may represent the phase of the frequency component corresponding to the coordinate (e.g., edge information, spatial arrangement information, etc. for the objects).

Similarly, the processor may perform a Fourier transform on the target image 730 of the first domain style to obtain an amplitude map and a phase map. Here, the amplitude map is information related to light, color characteristics, etc., for the target image 730 of the first domain style, and may correspond to the second color characteristics information 740. In addition, the phase map may be edge information for objects in the target image 730 of the first domain style.

In an embodiment, the processor may transform the first color characteristics information 720 for the combined image 710 into the second color characteristics information 740 for the target image 730 of the first domain style. For example, the processor may transform the first color characteristics information 720 for a first region of an amplitude map of the combined image 710 (hereinafter referred to as a ‘first amplitude map’) into the second color characteristics information 740 for a second region of an amplitude map of the target image 730 of the first domain style (hereinafter referred to as a ‘second amplitude map’). Here, the first region is a region close to the origin on the coordinate system of the first amplitude map, and may be determined as a low-frequency band region. That is, the first region may represent a region where the variation of light, color characteristics, etc., according to the position of a pixel on the combined image 710 is relatively small. In addition, the second region is a region close to the origin on the coordinate system of the second amplitude map, and may be determined as a low-frequency band region. That is, the second region may represent a region where the variation of light, color characteristics, etc., according to the position of a pixel on the target image 730 of the first domain style is relatively small. The second region of the second amplitude map may be a region corresponding to the first region of the first amplitude map. The shape, size, position, etc., of the first region and/or the second region may be determined differently depending on the resolution of the image, the target color characteristics transformation intensity, etc.

In an embodiment, the processor may inject the second color characteristics information 740 for the second region of the second amplitude map into the first region of the first amplitude map. Thereafter, the processor may generate the synthetic image 750 of the second domain style by performing an inverse Fourier transform on the amplitude map and the phase map of the combined image 710 into which the second color characteristics information 740 has been injected. For example, the processor may generate the synthetic image 750 of the second domain style by maintaining the color characteristics information associated with the region other than the first region of the first amplitude map (e.g., the high-frequency band region) and the phase information associated with the phase map of the combined image 710, while transforming only the first color characteristics information 720 associated with the first region of the first amplitude map. Accordingly, the shapes of the objects in the synthetic image 750 of the second domain style are maintained identically/similarly to the shapes of the objects in the combined image 710, and the overall color characteristics of the synthetic image 750 of the second domain style may be corrected to be similar to the overall color characteristics of the target image 730.

In another embodiment, the processor may calculate first color characteristics information 720 for a first region, which is at least a partial region extracted from within the combined image 710. In addition, the processor may calculate second color characteristics information 740 for a second region, which is at least a partial region extracted from within the target image 730 of the first domain style. The second region extracted from within the target image 730 of the first domain style may be a region corresponding to the first region extracted from within the combined image 710.

In an embodiment, the processor may transform the first color characteristics information 720 for the first region in the combined image 710 into the second color characteristics information 740 for the second region in the target image 730 of the first domain style. For example, the processor may inject the second color characteristics information 740 for the second region in the target image 730 of the first domain style into the first region in the combined image 710, based on the amplitude maps and phase maps obtained from each of the combined image 710 and the target image 730 of the first domain style. With this configuration, the color characteristics of the boundary portion between the first partial synthetic image and the second partial synthetic image in the combined image 710 is corrected to connect naturally, so that a more natural, high-quality synthetic image 750 of the second domain style may be generated.

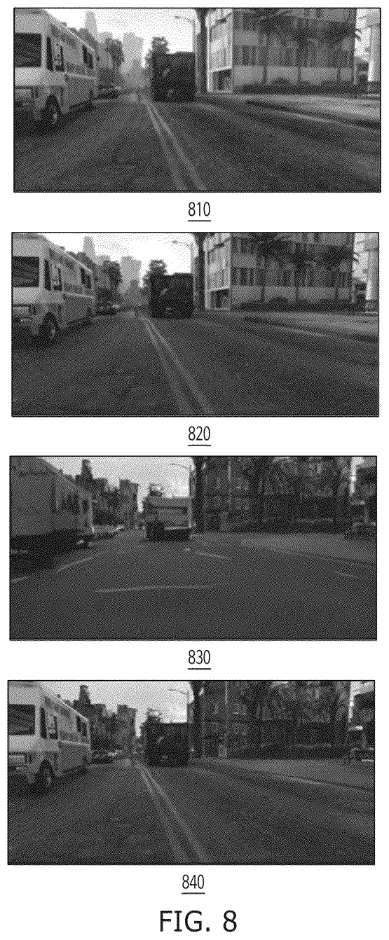

FIG. 8 illustrates an example of an image generated according to a synthetic image generation method according to an embodiment of the present disclosure. The first image is an example of a target image 810 of a first domain style. The first domain style may be a synthetic domain style generated through a computer simulation or a computer game. That is, the first image may be a syntheticly generated target image 810 for generating a synthetic image according to the method of the present disclosure.

The second image is an example of a first partial synthetic image 820 of a second domain style generated using a first image generation model. The second domain style may be a realistic domain style, like one captured with a specific camera. Referring to the second image, it can be confirmed that the first partial synthetic image 820 and the target image 810 have different domain styles, but the appearances of the objects in the images are identical or similar on a pixel-wise basis. Specifically, it can be confirmed that in the first partial synthetic image 820, the appearances of the objects in the target image 810 are maintained completely identically (or similarly), while the atmosphere, color characteristics, light intensity, etc. of the image are changed.

The third image is an example of a second partial synthetic image 830 of a second domain style generated using a second image generation model. Referring to the third image, it can be confirmed that in the segmentation region for the objects in the target image 810 of the first domain style, an image of an object with the same class but a different style from the objects in the target image 810 is generated in the second partial synthetic image 830. At this time, it can be confirmed that the shape of the second type of object is partially distorted in the second partial synthetic image 830. For example, it can be confirmed that the lane, which is an object related to vehicle driving, is distorted. Additionally, it can be confirmed that the second partial synthetic image 830 has a different domain style from the target image 810.

The fourth image is an example of a synthetic image 840 of a second domain style generated based on the first partial synthetic image 820 associated with a first type of object and the second partial synthetic image 830 associated with a second type of object. Specifically, a processor may generate a first image associated with the first type of object in the target image 810 of the first domain style, and generate the first partial synthetic image 820 based on the first image using a first image generation model. In addition, the processor may generate a second image associated with the second type of object in the target image 810 of the first domain style, and generate the second partial synthetic image 830 based on the second image using a second image generation model. Additionally, the processor may generate the synthetic image 840 of the second domain style by combining the first partial synthetic image 820 and the second partial synthetic image 830 and then performing a post-processing operation. Referring to the synthetic image 840 of the second domain style and the target image 810 of the first domain style, it can be confirmed that the first type of object (for example, a vehicle, a lane, etc.) in the synthetic image 840 of the second domain style has a completely identical (or similar) appearance to the first type of object included in the target image 810 of the first domain style, and only the color characteristics, light intensity, etc. are changed. In addition, it can be confirmed that the second type of object (for example, the sky, a building, etc.) in the synthetic image 840 of the second domain style has the same class information as the second type of object included in the target image 810 of the first domain style, but the style of the object is changed.

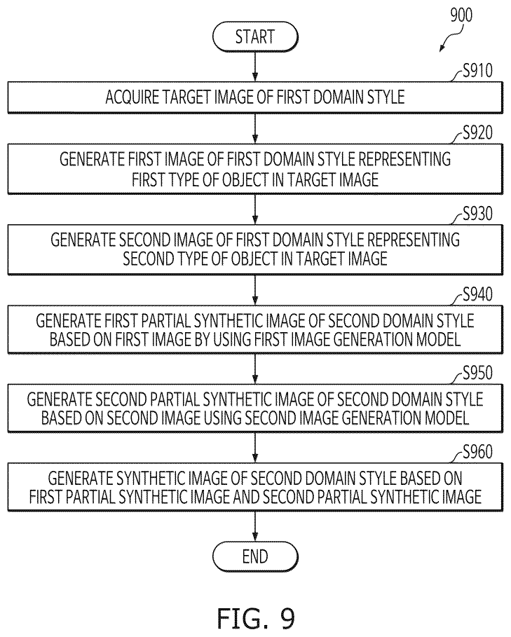

FIG. 9 is a flowchart illustrating a synthetic image generation method 900 according to an embodiment of the present disclosure. In an embodiment, the method 900 may be performed by at least one processor of an information processing system. The method 900 may begin with the processor acquiring a target image of a first domain style (S910). Here, the first domain style may be a synthetic domain style.

Then, the processor may generate a first image of the first domain style representing a first type of object in the target image (S920). Here, the first type of object may be an object distinguished and defined for each instance object. Additionally or alternatively, the first type of object may include a dynamic object and a first static object. The first static object may be an object associated with traffic information. In addition, the first image may include RGB information for the first type of object.

Then, the processor may generate a second image of the first domain style representing a second type of object in the target image (S930). Here, the second type of object may be an object distinguished and defined as a class according to an attribute of the object. Additionally or alternatively, the second type of object may include a second static object. In addition, the second image may include segmentation information for the second type of object.

Then, the processor may generate a first partial synthetic image of a second domain style based on the first image, using a first image generation model (S940). Here, the second domain style may be a realistic domain style. The first image generation model may be a model trained to generate an output image of the second domain style based on an input image of the first domain style.

Then, the processor may generate a second partial synthetic image of the second domain style based on the second image, using a second image generation model (S950). The second image generation model may be a model trained to generate an output image of the second domain style based on segmentation information.

Then, the processor may generate a synthetic image of the second domain style based on the first partial synthetic image and the second partial synthetic image (S960). The step of generating the synthetic image of the second domain style may include: generating a combined image by combining the first partial synthetic image and the second partial synthetic image; extracting at least a partial region in the combined image where the first partial synthetic image and the second partial synthetic image are adjacent; and transforming first color characteristics information for the at least a partial region.

According to an embodiment, to transform the first color characteristics information, the processor may extract, from the target image, second color characteristics information corresponding to the at least a partial region. Thereafter, the processor may transform the first color characteristics information for the at least a partial region in the combined image into the second color characteristics information.

The method described above may be provided as a computer program stored on a computer-readable recording medium for execution on a computer. The medium may continuously store a computer-executable program, or temporarily store it for execution or download. In addition, the medium may be various recording means or storage means in the form of a single or several combined hardware, and is not limited to a medium directly connected to a computer system, but may be distributed on a network. Examples of the medium may include magnetic media such as hard disks, floppy disks, and magnetic tapes, optical recording media such as CD-ROMs and DVDs, magneto-optical media such as floptical disks, and hardware configured to store program instructions, including ROM, RAM, flash memory, etc. In addition, other examples of media include recording media or storage media managed by app stores that distribute applications or sites and servers that supply or distribute various other software.

The methods, operations, or techniques of the present disclosure may be implemented by various means. For example, these techniques may be implemented in hardware, firmware, software, or a combination thereof. Those of ordinary skill in the art will understand that the various exemplary logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. A person of ordinary skill in the art may implement the described functionality in varying ways for each particular application, but such implementation decisions should not be interpreted as causing a departure from the scope of the present disclosure.

In a hardware implementation, the processing units used to perform the techniques may be implemented within one or more ASICs, DSPs, GPUs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, a computer, or a combination thereof.

Accordingly, the various exemplary logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In a firmware and/or software implementation, the techniques may be implemented as instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, a compact disc (CD), a magnetic or optical data storage device, etc. The instructions may be executable by one or more processors and may cause the processor(s) to perform certain aspects of the functionality described in the present disclosure.

When implemented in software, the techniques may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to a processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Although the embodiments described above have been described as utilizing aspects of the presently disclosed subject matter in one or more standalone computer systems, the present disclosure is not so limited, but may be implemented in connection with any computing environment, such as a network or a distributed computing environment. Furthermore, aspects of the subject matter in the present disclosure may be implemented in a plurality of processing chips or devices, and storage may similarly be affected across a plurality of devices. Such devices may include PCs, network servers, and portable devices.

Although the present disclosure has been described in connection with some embodiments herein, various modifications and changes may be made without departing from the scope of the present disclosure, which can be understood by a person of ordinary skill in the art to which the present disclosure pertains. In addition, such modifications and changes should be considered to fall within the scope of the appended claims.

What is claimed is:

1. A method performed by at least one processor of an apparatus, the method comprising:
acquiring a target image of a first domain style;
generating a first image of the first domain style representing a first type of object in the target image;
generating a second image of the first domain style representing a second type of object in the target image;
generating a first partial synthetic image of a second domain style, based on the first image, using a first image generation model;
generating a second partial synthetic image of the second domain style, based on the second image, using a second image generation model;
generating, based on the first partial synthetic image and the second partial synthetic image, a synthetic image of the second domain style; and
outputting the synthetic image of the second domain style,
wherein the first domain style and the second domain style are different from each other.

2. The method as claimed in claim 1, wherein the first domain style is a synthetic domain style, and
the second domain style is a realistic domain style.

3. The method as claimed in claim 1, wherein the first type of object is an object distinguished and defined for each instance object, and
the second type of object is an object distinguished and defined as a class according to an attribute of the object.

4. The method as claimed in claim 1, wherein the first image comprises red-green-blue (RGB) information for the first type of object, and
the second image comprises segmentation information for the second type of object.

5. The method as claimed in claim 1, wherein the first image generation model is a model trained to generate an output image of the second domain style based on an input image of the first domain style.

6. The method as claimed in claim 1, wherein the second image generation model is a model trained to generate an output image of the second domain style based on segmentation information.

7. The method as claimed in claim 1, wherein the generating the synthetic image of the second domain style comprises:
generating a combined image by combining the first partial synthetic image and the second partial synthetic image;
extracting at least a partial region in the combined image where the first partial synthetic image and the second partial synthetic image are adjacent; and
transforming first color characteristics information for the at least a partial region.

8. The method as claimed in claim 7, wherein the transforming the first color characteristics information comprises:
extracting, from the target image, second color characteristics information corresponding to the at least partial region; and
transforming the first color characteristics information for the at least partial region in the combined image into the second color characteristics information.

9. The method as claimed in claim 1, wherein:
the first type of object comprises a dynamic object and a first static object,
the second type of object comprises a second static object, and
the first static object is an object associated with traffic information.

10. A computer-readable non-transitory recording medium storing instructions that, when executed by a computer, cause the computer to perform the method according to claim 1.

11. An information processing system comprising:
a transceiver;
a memory; and
at least one processor connected to the memory and configured to execute at least one computer-readable program included in the memory,
wherein the at least one program comprises instructions that cause the information processing system to:
acquire a target image of a first domain style,
generate a first image of the first domain style representing a first type of object in the target image,
generate a second image of the first domain style representing a second type of object in the target image,
generate a first partial synthetic image of a second domain style based on the first image, using a first image generation model,
generate a second partial synthetic image of the second domain style based on the second image, using a second image generation model,
generate, based on the first partial synthetic image and the second partial synthetic image, a synthetic image of the second domain style, and
output the synthetic image of the second domain style, and
wherein the first domain style is different from the second domain style.
